(19) United States
(12) Patent Application Publication
(10) Pub. No.: US 2026/0270486 A1
(43) Pub. Date: Sep. 10, 2026

(54) METHOD AND APPARATUS FOR VIDEO CODING USING IMPLICIT NEURAL REPRESENTATION MODEL

(71) Applicants: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(72) Inventors: Je Won Kang, Seoul (KR); Ju Yeon Shin, Seoul (KR); Jung Ah Choi, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); EWHA UNIVERSITY – INDUSTRY COLLABORATION FOUNDATION, Seoul (KR)

(21) Appl. No.: 19/164,507

(22) PCT Filed: Jan. 12, 2024
(86) PCT No.: PCT/KR2024/000619

§ 371 Date: Sep. 11, 2025

(30) Foreign Application Priority Data
Mar. 20, 2023 (KR) 10-2023-0035657
Jan. 11, 2024 (KR) 10-2024-0004603

(51) Int. Cl. H04N 19/82; G06N 3/08; H04N 19/176

(52) U.S. Cl. CPC H04N 19/82; G06N 3/08; H04N 19/176

(57) ABSTRACT

A method and an apparatus are disclosed for video coding using an implicit neural representation model. In the disclosed embodiments, the video decoding device obtains a model of Neural Representations for Videos (NeRV model) and constructs an input to the NeRV model. The video decoding device applies the input to the NeRV model to output an N block that corresponds to a residual block of the current block, a prediction block of the current block, a reconstructed block of the current block, or a loop filtered block of the current block. The video decoding device decodes a type of the N block from a bitstream and applies a video decoding process based on a type of the N block, to the N block.

### TECHNICAL FIELD

The present disclosure relates to a video coding method and an apparatus using an implicit neural representation model.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Recently, deep learning-based image processing techniques have been applied to existing coding element technologies. Among the existing coding technologies, compression techniques such as inter prediction, intra prediction, in-loop filter, transform, or the like may employ deep learning-based image processing techniques to increase coding efficiency. Typical application examples include inter prediction based on a virtual reference frame generated by deep learning, in-loop filter based on a denoising model, and the like.

Meanwhile, there has been recently active research on implicit neural representation models that represent various data including images in a neural network structure. A conventional video representation method used is an explicit representation method with RGB pixel values represented for each pixel position. To replace this explicit representation method, an implicit neural representation method is newly introduced, representing a function by a neural network for converting the (x,y) coordinates of the video pixel position into (r,g,b) values. Compared to the explicit representation method, the implicit neural representation method can be used regardless of the resolution of the images. Therefore, there is a need for applying the implicit neural representation method to video coding to increase video coding efficiency and enhance video quality.

### DISCLOSURE

### Technical Problem

The present disclosure seeks to provide a video coding method and an apparatus utilizing an implicit neural representation model operating in an N block or an N frame. Herein, the N block and the N frame refer to a block and a frame that are coded by using the implicit neural representation model, respectively.

The present disclosure seeks to provide a video coding method and an apparatus for performing prediction or in-loop filtering of the N block or the N frame by using an implicit neural representation model.

### Technical Solution

At least one aspect of the present disclosure provides a method of reconstructing a current block by a video decoding apparatus. The method includes obtaining a model of Neural Representations for Videos (NeRV model). The method also includes constructing an input to the NeRV model. The method also includes applying the input to the NeRV model to output an N block that corresponds to a residual block of the current block, a prediction block of the current block, a reconstructed block of the current block, or a loop filtered block of the current block. The method also includes decoding a type of the N block from a bitstream. The method also includes applying a video decoding process based on a type of the N block, to the N block.

Another aspect of the present disclosure provides a method of encoding a current block by a video encoding apparatus. The method includes applying a video encoding process to an original block of the current block to generate a first block that is a loop filtered block of the current block. The method also includes constructing an input to a model of Neural Representations for Videos (NeRV model). The method also includes constructing the NeRV model based on the input. The method also includes applying the input to the NeRV model to output an N block that corresponds to a residual block of the current block, a prediction block of the current block, a reconstructed block of the current block, or a loop filtered block of the current block. The method also includes applying a video decoding process based on a type of the N block, to the N block to generate a second block that corresponds to the loop filtered block of the current block.

Yet another aspect of the present disclosure provides a computer-readable recording medium storing a bitstream generated by a video encoding method. The video encoding method includes applying a video encoding process to an original block of a current block to generate a first block that is a loop filtered block of the current block. The video encoding method also includes constructing an input to a model of Neural Representations for Videos (NeRV model). The video encoding method also includes constructing the NeRV model based on the input. The video encoding method also includes applying the input to the NeRV model to output an N block that corresponds to a residual block of the current block, a prediction block of the current block, a reconstructed block of the current block, or a loop filtered block of the current block. The video encoding method also includes applying a video decoding process based on a type of the N block, to the N block to generate a second block that corresponds to the loop filtered block of the current block.

### Advantageous Effects

As described above, the present disclosure provides a video coding method and an apparatus that utilize an implicit neural representation model that operates in an N block or an N frame. Thus, the video coding method and the apparatus increase video coding efficiency in the process of transmitting additional information required for coding the N block and the N frame.

Further, the present disclosure provides a video coding method and an apparatus that perform prediction or in-loop filtering of the N block or the N frame by using an implicit neural representation model. Thus, the video coding method and the apparatus enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating the operation of a convolution layer.

FIG. 7 is a diagram illustrating a single image super resolution (SISR) network.

FIG. 8 is a diagram illustrating a residual block utilized in SISR.

FIG. 9 is a diagram illustrating a convolutional neural network- (CNN-) based fixed-coefficient in-loop filter.

FIG. 10 is a diagram illustrating a Neural Representations for Videos (NeRV) model.

FIGS. 11A and 11B are diagrams illustrating the concept of a NeRV model according to at least one embodiment of the present disclosure.

FIG. 12 is a diagram illustrating an encoding pipeline of a NeRV model, according to at least one embodiment of the present disclosure.

FIG. 13 is a diagram illustrating a decoding pipeline of a NeRV model, according to at least one embodiment of the present disclosure.

FIG. 14 is a diagram illustrating a block-based NeRV model, according to at least one embodiment of the present disclosure.

FIG. 15 is a diagram illustrating a block-based NeRV model according to another embodiment of the present disclosure.

FIG. 16 is a diagram illustrating a frame-based NeRV model according to at least one embodiment of the present disclosure.

FIG. 17 is a diagram illustrating an application of a NeRV model, according to at least one embodiment of the present disclosure.

FIG. 18 is a diagram illustrating an application of the NeRV model, according to another embodiment of the present disclosure.

FIG. 19 is a diagram illustrating an application of the NeRV model, according to yet another embodiment of the present disclosure.

FIG. 20 is a diagram illustrating an application of the NeRV model, according to yet another embodiment of the present disclosure.

FIG. 21 is a flowchart of a method of encoding the current block by a video encoding apparatus, according to at least one embodiment of the present disclosure.

FIG. 22 is a flowchart of a method of reconstructing the current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

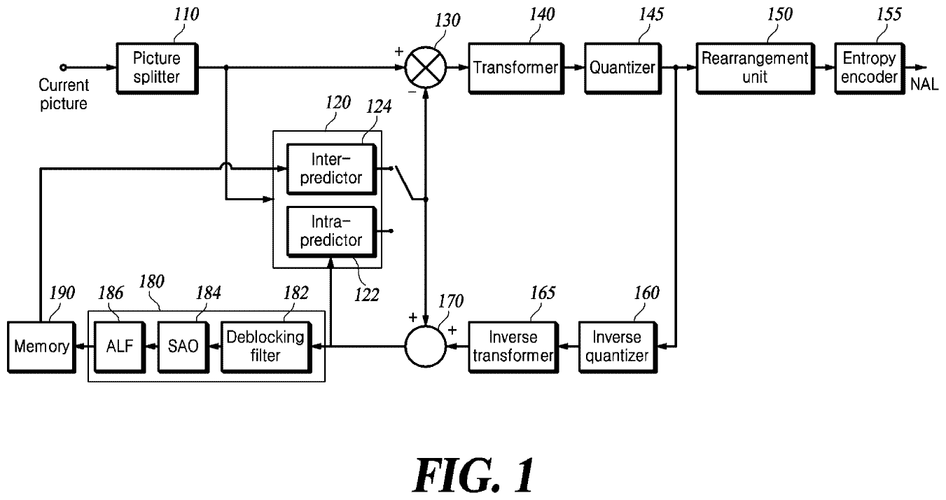

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

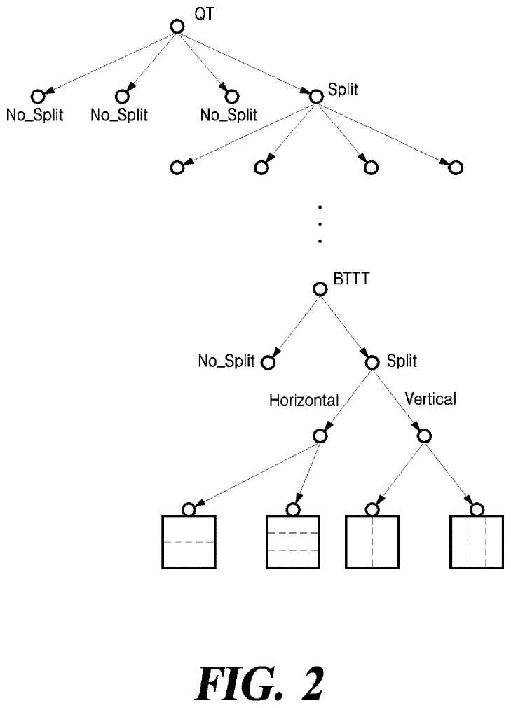

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

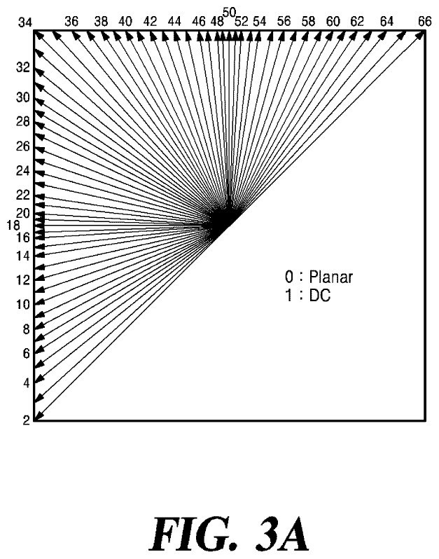

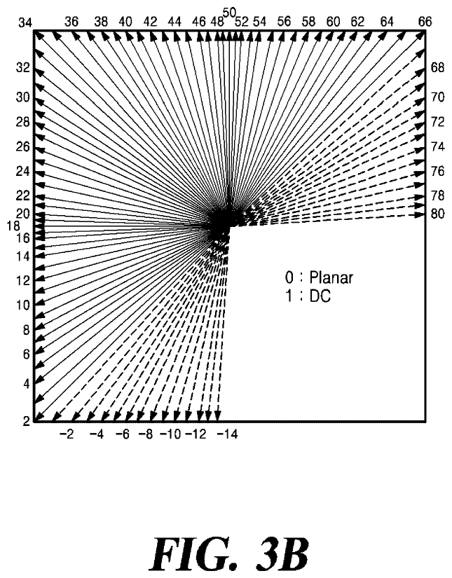

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (intra prediction modes #67 to #80, #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

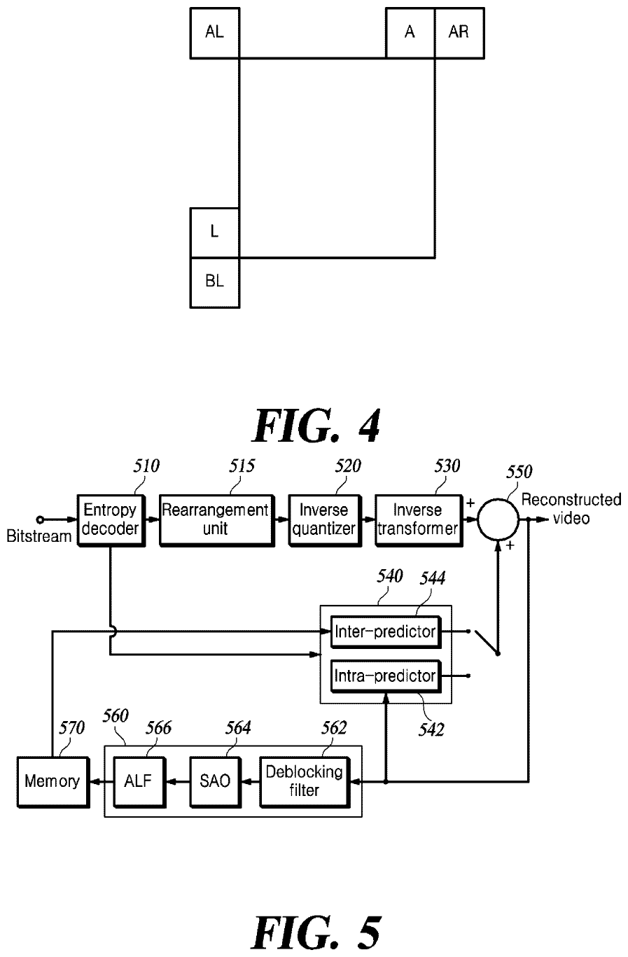

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510, and predicts the current block by using the motion vector and the reference picture.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that utilize an implicit neural representation model that operates in unit of N block or N frame. Here, the N block refers to a block that is coded by using the implicit neural representation model, and the N frame refers to a frame that is coded by using the implicit neural representation model. In addition, the present disclosure provides video coding methods and apparatuses for performing prediction or in-loop filtering of the N block or the N frame by using the implicit neural representation model.

The following embodiments may be performed by a plurality of components in the video encoding device. The following embodiments may also be performed by a plurality of components in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Convolutional Neural Network (CNN)

CNN refers to a neural network composed of a plurality of convolutional layers and pooling layers and is a deep learning technique known to be best suited for image processing. The convolutional layer uses a plurality of kernels or filters to extract a feature map, also referred to as a ‘feature’. The kernel coefficients that constitute the filters are the parameters that are determined during the learning process.

Among the convolutional layers of the CNN, a frontend layer close to the input extracts feature maps that respond to simple, low-level image features such as lines, points, or faces. Among the convolutional layers of the CNN, a backend layer close to the output extracts feature maps that respond to higher-level features such as textures and object parts.

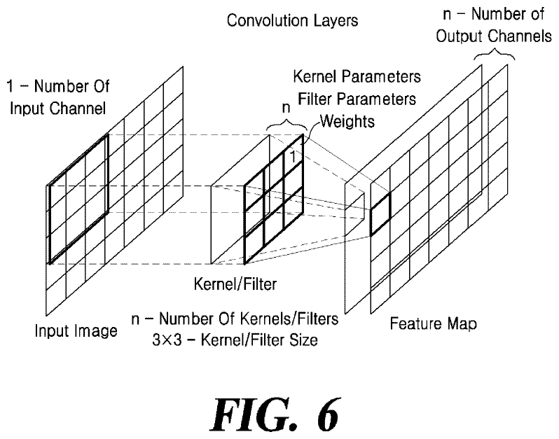

FIG. 6 is a diagram illustrating the operation of a convolutional layer, according to at least one embodiment of the present disclosure.

The convolutional layer utilizes a convolutional operation to generate a feature map from the input image. The example of FIG. 6 depicts a kernel (or filter) with a kernel size of 3×3. The kernel size is also referred to as the filter size. The kernel has a kernel parameter or filter parameter, also referred to as a weight. The kernel illustrated in FIG. 6 has a total of nine kernel parameters. The kernel parameters may be initially set to random values, and their values may be updated based on training.

The convolutional layer performs a convolutional operation by using a block equal to the kernel size in the input image. In this case, the block equivalent to the kernel size in the input image is referred to as a window.

When filtering the input image is performed in a raster-scan order, the amount of the movement of the window is called a stride. In the example of FIG. 6, the stride is 1. If the stride is set to 2, the convolutional operation is performed shifting the window by 2 samples, resulting in the horizontal and vertical dimensions of the feature map being half the horizontal and vertical dimensions of the input image.

As mentioned above, a convolutional layer may include a plurality of filters. The number of filters or the number of kernels is referred to as the number of channels. Namely, the number of channels is equal to the number of filters. The number of filters also determines the dimensionality of the feature map.

Padding refers to a method of expanding the input data by filling in a certain value around the input data before performing a convolutional operation. Padding is often used to control the spatial size of the output data. The value used for padding may be determined by hyperparameters, but zero padding is commonly used. If no padding is used, the spatial size of the output data decreases with each pass through the convolutional layer, which may cause boundary information to be lost. Thus, to avoid this issue, padding is used. Padding can be used to equalize the spatial size of the convolutional layer's output data and input data.

The deconvolutional layer performs the opposite operation of the convolutional layer. The deconvolutional layer generates a desired data image as an output from a feature map which is an input.

The pooling layer performs pooling, which is the process of subsampling the feature map generated by the convolutional layer. The pooling layer utilizes a 2×2 window to select samples such that the output is half the width and half the height of the input. In other words, the pooling layer is utilized to reduce the size of the input image or input feature map by condensing a 2×2 region into a single sample.

The opposite of a pooling layer is defined as an unpooling layer. An unpooling layer serves to increase dimensionality as opposed to a pooling layer and is typically used after a deconvolutional layer.

A convolutional encoder-decoder structure is a network structure composed of pairs of convolutional and deconvolutional layers. A convolutional encoder is composed of a convolutional layer and a pooling layer to output a feature map (or feature vector) from an input image. The final output vector of a convolutional encoder is also referred to as a latent vector. A convolutional decoder is composed of a deconvolutional layer and an unpooling layer to generate an output image from the feature map or latent vector.

The inputs and outputs of the convolutional encoder-decoder may vary depending on the purpose of the application and network. For example, the inputs and outputs may be optical flow maps, saliency maps, image frames, etc.

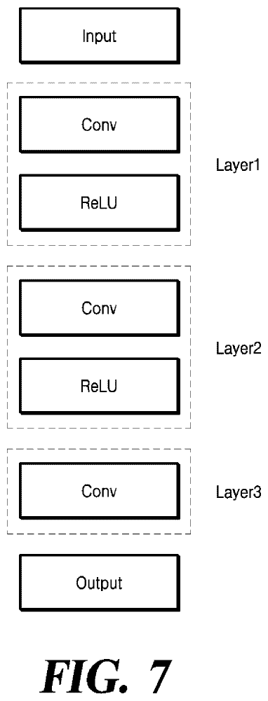

FIG. 7 is a diagram illustrating a SISR network.

One example application of CNN is Single Image Super Resolution (SISR). A SISR network generates a high-resolution output image from a low-resolution input image. A SISR network may include multiple convolutional layers, as illustrated in FIG. 7. Each convolutional layer includes an activation function, such as a Rectified Linear Unit (ReLU). The parameters of the SISR network may be trained such that the resulting super-resolution (SR) image is close to the ground truth (GT).

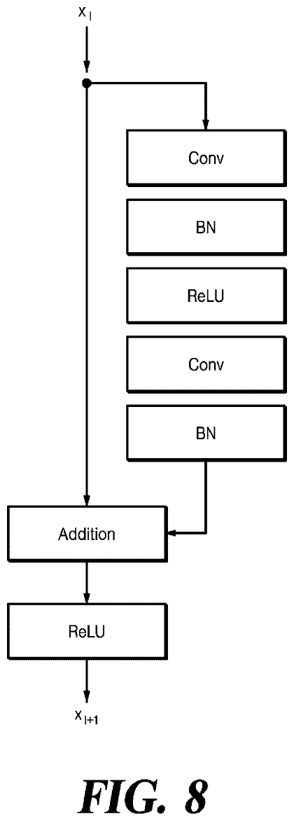

SR methods using CNNs can improve SR performance by increasing the depth, e.g., by increasing the number of convolutional layers. To overcome the problem of overfitting in learning, which may occur with increasing depth, the SISR network may utilize a residual block that may perform skip connections and residual learning. As illustrated in FIG. 8, the residual block includes a skip path in addition to a path for applying a convolutional operation to the input feature x1. In addition, the residual block when generating the output x1+1 may select the path of applying the convolutional operation based on learning efficiency or the skip path. In the example of FIG. 8, the residual block includes a batch normalization (BN) layer.

In one example, Enhanced Deep residual networks for SISR (EDSR) enhance the performance of the network by increasing the depth by concatenating residual blocks in succession. Another example is Accurate Image Super-Resolution Using Very Deep Convolutional Networks (VDSR), a CNN model based on Visual Geometry Group networks (VGG networks) that uses residual learning, which is the addition of residual frames to the final output. VDSR adds the residual signal at the very end of the network and thereby adds the residual signal to the input signal.

As another example, a CNN may be utilized as an in-loop filter in the video encoding apparatus or video decoding apparatus. In this case, the deep learning-based in-loop filter may be employed at any location within the existing loop filter unit 180 or 560 composed of the deblocking filter, the SAO filter, and the ALF.

The deep learning-based in-loop filter may be a fixed coefficient in-loop filter. The deep learning-based fixed coefficient in-loop filter utilizes the common CNN kernel parameters stored on both sides of the video encoding apparatus and video decoding apparatus.

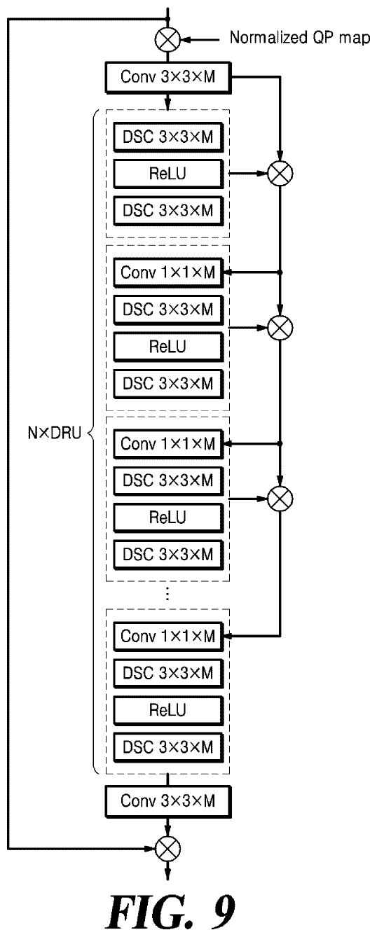

FIG. 9 is a diagram illustrating a CNN-based fixed coefficient in-loop filter.

Input blocks (or input frames) are passed through a normalized QP map and passed to subsequent stages. The normalized QP map is used to reduce inference error when different intensities of quantized noise are mixed in the learning and inference process. The kernel parameters that constitute the dense residual unit (DRU) and convolutional layer may be stored and used identically in the video encoding apparatus and the video decoding apparatus. In the example of FIG. 9, each DRU may include all or part of a convolutional layer, a ReLU layer, and a depth-wise separable convolutional (DSC) layer.

Deep learning-based fixed coefficient in-loop filters need to provide general performance over a wide range of video frames and therefore they have the disadvantage of increasing the number of layers deep down into the CNN and correspondingly prolonging computation time.

### II. Implicit Neural Representation Model

Recently, there has been active research on implicit neural representation models that represent various data including images in a neural network structure. A conventional video representation method used is an explicit representation method with RGB pixel values represented for each pixel position. To replace this explicit representation method, an implicit neural representation method is newly introduced, representing a function by a neural network for converting the (x,y) coordinates of the video pixel position into (r,g,b) values. Compared to the explicit representation method, the implicit neural representation method can be used regardless of the resolution of the images. Therefore, for the implicit neural representation model, a multi-layer perceptron (MLP) network may be used including multiple fully-connected layers (FC).

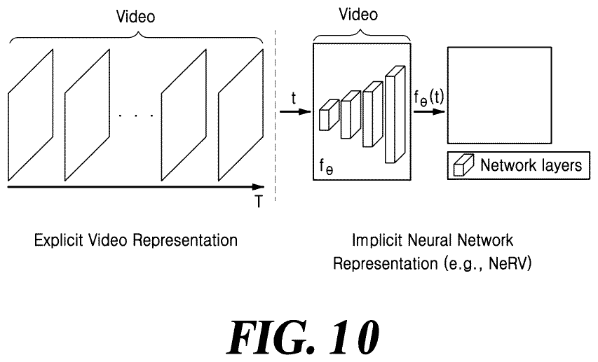

One example of the implicit neural representation model is implicit Neural Representations for Video. Hereinafter, the model of implicit Neural Representations for Videos is referred to as the NeRV model. As mentioned above, the explicit representation method represents pixel values on an (x,y,t) grid by using the pixel position (x,y) in the image and the time index t of the frame. The implicit neural representation model outputs RGB pixel values from an input representing the position in (x,y,t). However, training a neural network at every position in (x,y,t) can significantly increase the computational complexity, so the NeRV model outputs the RGB image of the entire frame at time index t by using a neural network structure with only time index t used as input, as illustrated in FIG. 10.

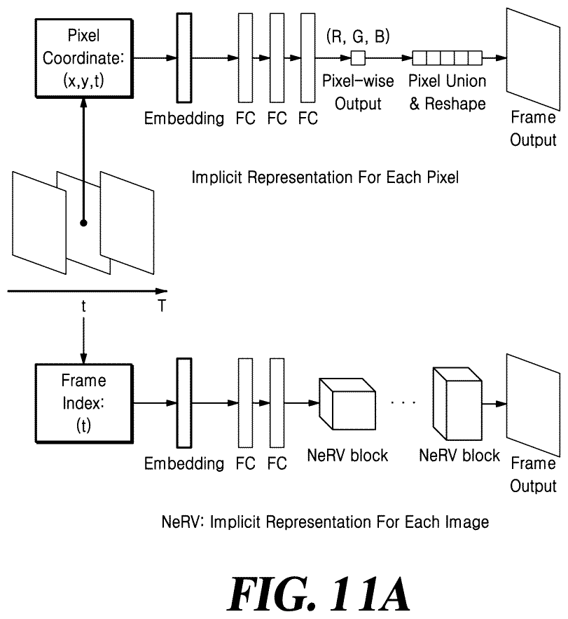

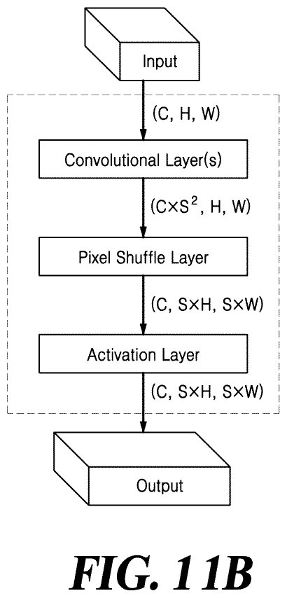

FIGS. 11A and 11B are diagrams illustrating the concept of a NeRV model according to at least one embodiment of the present disclosure.

To facilitate providing image output for a time index t input, utilizing convolutional layers can be more effective than to utilize the existing implicit representation model's MLP (Multi-layer Perceptron) networks. The NeRV model may utilize a stacked structure of NeRV blocks composed of multiple convolutional layers to generate output. As illustrated in FIG. 11A, an MLP-based output and a NeRV block-based output may be compared. The NeRV block includes convolution layers performing convolutions, a pixel shuffle layer, and an activation layer, as illustrated in FIG. 11B. In the example of FIG. 11B, C denotes the number of channels, W and H denote the width and height of the input of the NeRV block, and S denotes the upscaling factor.

Further, the NeRV model embeds time index t into a higher dimensional space and uses the embedded index as an input, as shown in Equation 1.

γ(t)=(sin(2⁰πt),cos(2⁰πt), . . . ,sin(2^{L-1}πt),cos(2^{L-1}πt)) [Equation 1]

As illustrated in Equation 1, time index t may be mapped to a 2L-dimensional vector γ(t). By training the NeRV model with the embedded time index t, the present disclosure enables the NeRV model to better predict video data containing high frequency variations.

As a loss function of the NeRV model, a combination of L1 loss and a structural similarity index loss (SSIM loss) may be used. During training of the NeRV model, these losses may be calculated at all pixel locations in the image estimated by the NeRV model based on the input and in the ground-truth (GT) image, i.e., the original image. The L1 loss is calculated by using the absolute value of the difference between the pixels in the estimated image and the GT image. The SSIM loss is calculated based on the mean, standard deviation, and correlation of the pixels in the estimated image and the GT image. Based on the calculated losses and during the training process, the weights (or parameters) that constitute the NeRV model may then be updated.

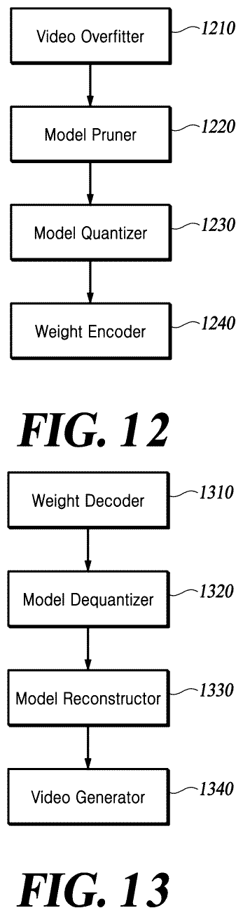

FIG. 12 is a diagram illustrating an encoding pipeline of a NeRV model, according to at least one embodiment of the present disclosure.

Since the NeRV model may be used to approximate the original video, compressing and transmitting the NeRV model can implement end-to-end compression techniques using neural networks. An encoding pipeline for encoding the NeRV model may include all or part of a video overfitter 1210, a model pruner 1220, a model quantizer 1230, and a weight encoder 1240, as illustrated in FIG. 12.

The video overfitter 1210 represents the input video frames by the NeRV model. The video encoding apparatus trains the NeRV model by using the loss function described above to cause the NeRV model to represent the video frame. The model pruner 1220 uses pruning to simplify the NeRV model structure which may be an MLP (multi-layer perceptron) or a mixture of the MLP and convolutional layers. For example, pruning sets weights smaller than a preset threshold to zero. The model quantizer 1230 quantizes the pruned weights, e.g., weights greater than or equal to the threshold. The weight encoder 1240 applies entropy encoding to the quantized weights to generate a bitstream of weights.

A reverse order of the encoding pipeline illustrated in FIG. 12, the decoding pipeline for decoding the NeRV model may be illustrated as in FIG. 13. The decoding pipeline may include all or part of a weight decoder 1310, a model dequantizer 1320, a model reconstructor 1330, and a video generator 1340, as illustrated in FIG. 13.

The weight decoder 1310 applies entropy encoding to the bitstream of weights of the NeRV model to generate quantized weights. The model dequantizer 1320 de-quantizes the quantized weights to generate pruned weights. The model reconstructor 1330 reconstructs the NeRV model based on the pruned weights. The video generator 1340 uses the reconstructed NeRV model according to the time index to generate reconstructed video frames.

As described above, the NeRV model (model of implicit Neural Representations for Videos) utilizes the time index t of a frame as input. Thus, with a video inputted having pixels of size t×h×w, the NeRV model samples the input video only t times instead of t×h×w times, which may result in significant gains in both encoding and decoding speed.

### III. Embodiments According to the Present Disclosure

Hereinafter, the present disclosure applies NeRV-based neural network models to conventional video coding, such as VVC (versatile video coding). The present disclosure includes the following to improve the performance of video coding. First, the input form of the NeRV model is improved to be suitable for video coding. Existing NeRV models are either trained with the position information of all pixels or trained without the position information of pixels. However, video coding, which processes signals block by block, needs to train the NeRV model by CTU (Coding Tree Unit) or CU (Coding Unit) and extract the signals by using the index of each training unit.

The present disclosure can also be applied to encoding techniques such as in-loop filter, inter prediction, and the like used by VVC. In this case, a single NeRV model may be used. Alternatively, to improve coding efficiency, multiple NeRV models may be used, which are based on additional information of the coding device such as quantization parameter (QP), slice type, and the like. The present disclosure describes the use of NeRV models in the above-described encoding techniques.

Conventional implicit neural representation models utilize pixel indices (x,y,t) as input, which significantly increases complexity. NeRV models can output the entire frame by using a time index t as input, but it may lose spatial information. Conventional video coding devices, including VVC, divide a video frame into blocks and process the signals in each block. Therefore, by training the NeRV model with the indices of the blocks, the NeRV model can be more usefully applied to existing coding devices. Hereinafter, the term NeRV may refer to a more general approach, for an implicit neural representation model to include block indices (i, j), in addition to improving an existing NeRV model for the input to include block indices (i, j).

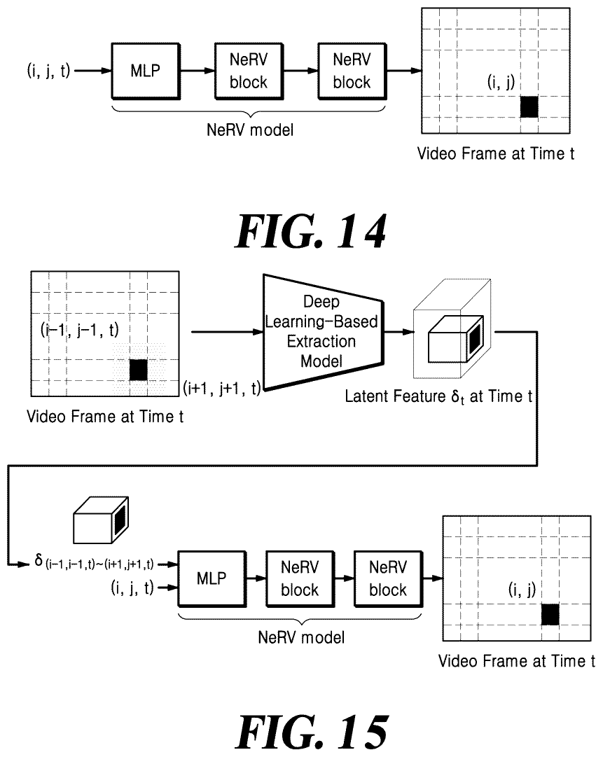

FIG. 14 is a diagram illustrating a block-based NeRV model, according to at least one embodiment of the present disclosure.

In one example, the block-based NeRV model takes as input an index (i, j) of a video block containing one or more pixels and a time index t to represent the signals in the video block corresponding to the index of the block. For example, in the example of FIG. 14, the indices (i, j) represent those of CTUs or CUs used by the video coding device. Like conventional NeRV, the block-based NeRV model is implemented by using a combination of the MLP and convolutional layers. As described above, the block index and the time index are embedded in a high-dimensional space as illustrated in Equation 1, and then the embedded block index and the embedded time index are used as inputs to the NeRV model.

For example, the video encoding apparatus trains the block-based NeRV model illustrated in FIG. 14 by using the above-described loss function to cause the NeRV model to represent the block. The video encoding apparatus transfers the block-based NeRV model to the video decoding apparatus by using the encoding pipeline described above. The video decoding apparatus reconstructs the block-based NeRV model by using the above-described decoding pipeline. The video decoding apparatus may then use the block-based NeRV model illustrated in FIG. 14 to reconstruct the block corresponding to the block index.

FIG. 15 is a diagram illustrating a block-based NeRV model according to another embodiment of the present disclosure.

As another example, in addition to the block index and time index, the block-based NeRV model may use, as input, the video frames' local features extracted from the deep learning-based extraction model. As local features, latent features are used, which include the features of the (i, j)th block or even the local features of the neighboring blocks. For example, a neighboring block is a block that has already completed decoding and represents samples from a block located to the left or top of the current block in intra prediction. In inter prediction, neighboring blocks represent the frame's blocks that are earlier in the decoding sequence. In the example of FIG. 15, the NeRV model additionally uses, as input, local feature δₜ that is the (i, j)th blocks' features and the neighboring blocks' features combined.

For example, the video encoding apparatus may train the extraction model and the block-based NeRV model illustrated in FIG. 15 end-to-end, allowing the extraction model to extract the local features and the NeRV model to represent the blocks. The video encoding apparatus transfers the block-based NeRV model to the video decoding apparatus by using the above-described encoding pipeline. The video encoding apparatus further encodes local features associated with the block and transfers the encoded local features to the video decoding apparatus. The video decoding apparatus reconstructs the block-based NeRV model by using the above-described decoding pipeline. Further, the video decoding apparatus decodes the local features. The video decoding apparatus may then input the block index, the time index, and the local features into the block-based NeRV model to reconstruct the block corresponding to the block index.

The NeRV model is encoded by the video encoding apparatus using the encoding pipeline, as illustrated in FIG. 12, and then transferred to the video decoding apparatus. The parameters (i.e., weights) of the trained model are encoded after their data size reduction by model pruning, quantization, and entropy encoding. The NeRV model may be implemented by using either floating point arithmetic or fixed point arithmetic with N (e.g., 8, 16, 32, or the like) bits of N (e.g., 8, 16, 32, or the like) bits, to allow for universality across heterogeneous devices such as central processing units (CPUs), graphics processing units (GPUs), etc. However, utilizing a NeRV model for every block may significantly increase the overall size of the video bitstream. Therefore, the video encoding apparatus may adaptively transmit a NeRV model per block rather than just transmitting all NeRV models on a block-by-block basis. For example, a new kind of block called an N block is defined in addition to the blocks generated by the prediction, such as I (Intra) block, P (Predicted) block, B (Bi-predicted) block, or the like. Instead of conventional construction of blocks by using a prediction block based on intra or inter prediction and a residual block combined, the video decoding apparatus generates an N block of signals based on the received NeRV model. The N block is represented by assign the type to the block header of the CU or CTU. The video decoding apparatus decodes the parameters of the NeRV model, and then decodes the N block by using the NeRV model.

Each N block may have parameters of the NeRV model. Further, each N block may copy the parameters of the NeRV model of a neighboring N block and may use the copied parameters directly. Alternatively, the copied parameters may be used as initial values for training of each N block. In the merge mode of VVC inter prediction, the video encoding apparatus copies the additional information of the neighboring blocks and uses the copied additional information. The video encoding apparatus may then reduce the bit rate required to transmit the additional information by exclusively transmitting an index on which of the neighboring blocks is to be used instead of transmitting all additional information required for inter prediction of the current block.

Similar to the VVC merge mode, by exclusively parsing the index indicating the previously decoded N block neighboring the current block, the video decoding apparatus may reconstruct the current N block by using the parameters of the NeRV model of the previously decoded N block. In addition to the models of spatially neighboring blocks, the video decoding apparatus also uses the models of spatially distant blocks.

The video encoding apparatus organizes a queue that manages parameters of the NeRV model associated with the N block and signals an index of the queue for transmitting information on the NeRV model. Alternatively, the video encoding apparatus utilizes parameters of the NeRV model associated with non-contiguous but spatially closest N block.

Meanwhile, if a frame is entirely composed of N blocks, the frame is defined as an N frame. Alternatively, a frame may be defined as an N frame if it contains at least one N block. Since a frame may be further divided into slices, a slice consisting of only N blocks is defined as an N slice. Alternatively, a slice containing at least N blocks is defined as an N slice.

Different NeRV models may be used for different N blocks within an N frame. Alternatively, where an N frame consists of only N blocks, a single NeRV model may be utilized. Where a single NeRV model is utilized, the input to the NeRV model does not require a block-by-block index. Namely, as with conventional NeRV models, the video encoding apparatus constructs the NeRV model by using an input structure that includes only a time index t, without including the block indices (i, j), and then encodes the constructed NeRV model. In another example, while maintaining an input structure utilizing block indices, the video encoding apparatus constructs the input by filling all (i, j) with (0, 0) or a range of values (e.g., negative values) that the existing (i, j) indices cannot have, and then trains the NeRV model by using the constructed input.

The video encoding apparatus may apply one or more NeRV models to the N blocks within the N frame.

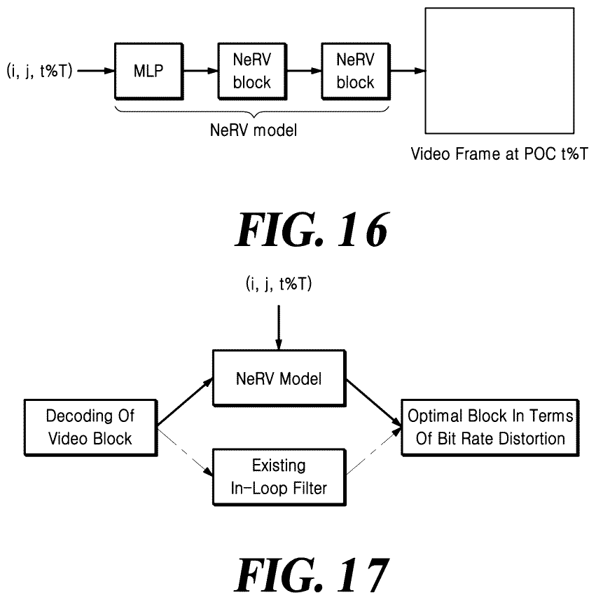

The video encoding apparatus may adaptively deliver the NeRV model per group of pictures (GOP). In one example, one NeRV model is utilized for one GOP. The video decoding apparatus may receive the NeRV model in the first instantaneous decoding refresh (IDR) frame of the GOP and apply the received model to the entire GOP. As another example, if T is the number of frames constituting the GOP, T NeRV models may be utilized. When applying the NeRV model to a GOP, as input to the NeRV model, the video encoding apparatus uses the picture order count (POC) which is the output order of the frames. Alternatively, the video encoding apparatus applies T modulo operations (% in the example in FIG. 16) to the time sequence t of the frames to produce a remainder, and uses the resulting remainder as the time index of the NeRV model. The time sequence t of the frames is determined by the POC or encoding order. In the example of FIG. 16, the remainder calculated by applying the T modulo operations to the time sequence t of the frames, as described above, is used as the time index of the NeRV.

For example, the video encoding apparatus trains the frame-based NeRV model illustrated in FIG. 16 by using the above-described loss function to allow the NeRV model to represent the frames. In the example of FIG. 16, the video encoding apparatus organizes the input by filling all (i, j) with (0,0) or a range of values (e.g., negative values) that the existing (i, j) index cannot have. The video encoding apparatus transfers the frame-based NeRV model to the video decoding apparatus by using the above-described encoding pipeline. The video decoding apparatus reconstructs the frame-based NeRV model by using the above-described decoding pipeline. The video decoding apparatus may then reconstruct the frame corresponding to the time index by using the frame-based NeRV model illustrated in FIG. 15.

Meanwhile, a conventional deep learning-based in-loop filter included in the video encoding apparatus or video decoding apparatus is trained by using a large amount of data in advance. When quantization noise is sufficiently removed from a typical video, one is supposed to construct a common deep learning module trained on the in-loop filter of the video encoding apparatus or video decoding apparatus, and perform encoding/decoding of the video based on the common deep learning module. At this time, the deep learning module is constructed so that the quantized noisy video samples after the encoding are close to the original samples, and is fixedly used in the video encoding apparatus or video decoding apparatus.

However, the performance of a deep learning module trained as described above may depend on the features of the samples used for training. For example, if unused samples are inputted during the training process, the performance of the deep learning module may be degraded not upgraded. This is because the video samples that are inputted during the actual video encoding process may have very different statistical features depending on the intensity of the quantization noise, the characteristics of the sensors used to create/generate the content, and the like.

An example of applying the above-described NeRV model to an in-loop filter is described below in terms of the video encoding apparatus.

FIG. 17 is a diagram illustrating an application of a NeRV model, according to at least one embodiment of the present disclosure.

In the example of FIG. 17, the video encoding apparatus reconstructs the first frame by using a conventional in-loop filter. Further, the video encoding apparatus trains the NeRV model by using the time index as an input and generates a second frame as an output of the NeRV model. The video encoding apparatus selects a frame that is optimal in terms of rate distortion between the first frame and the second frame. In another example, the video encoding apparatus reconstructs the first block by using a conventional in-loop filter. Further, the video encoding apparatus trains the NeRV model by using the block index and the time index as inputs, and generates a second block as an output of the NeRV model. The video encoding apparatus selects a block that is optimal in terms of rate distortion between the first block and the second block. The video encoding apparatus may then explicitly signal, to the video decoding apparatus, the frame/block level information about which one is to be used between the first frame/first block and the second frame/second block. Hereinafter, the information signaled is referred to as a NeRV utilization flag.

The following describes examples of applying the aforementioned NeRV model to intra prediction or inter prediction in terms of the video encoding apparatus.

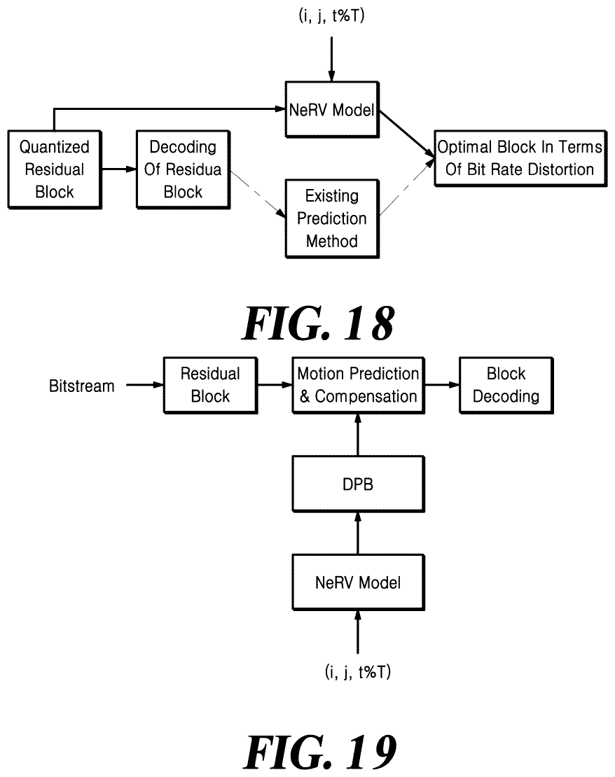

FIG. 18 is a diagram illustrating an application of the NeRV model, according to another embodiment of the present disclosure.

In the example of FIG. 18, the video encoding apparatus uses the NeRV model in place of all or part of the conventional inverse transformer 165, inverse quantizer 160, predictor 120, and adder 170. In a conventional prediction method, the video encoding apparatus decodes a residual block, generates a prediction block, and then sums the residual block and the prediction block to generate a first reconstructed block. However, with the N block provided, the video encoding apparatus may generate a second reconstructed block that is decoded by using the NeRV model. After constructing the input with a combination of the time index and/or block index of the block/frame to be decoded, the video encoding apparatus trains the NeRV model by using the constructed input and outputs the video block at the corresponding temporal and spatial location as the output of the NeRV model to generate the second reconstructed block. The video encoding apparatus selects a block that is optimal in terms of rate distortion between the first reconstructed block and the second reconstructed block. The video encoding apparatus may then explicitly signal, to the video decoding apparatus, the block level information about which one is to be used between the first reconstructed block or the second reconstructed block. After the video decoding apparatus decodes the information about whether to use the first reconstructed block or the second reconstructed block, the video decoding apparatus may use the NeRV model to replace the traditional prediction method based on the decoded information. As described above, the information signaled is referred to as a NeRV utilization flag.

In the example of FIG. 18, the NeRV model generates, but is not necessarily limited to, the block to be decoded. In one example, the NeRV model may be trained to output a prediction block that is generated by the predictor 120. The video encoding apparatus may generate a decoded block by summing the residual block generated by the inverse transformer 165 and the prediction block generated by the NeRV model. As another example, the NeRV model may be trained to output the residual block generated by the inverse transformer 165. The video encoding apparatus may generate a decoded block by summing the prediction block generated by the predictor 120 and a residual block generated by the NeRV model. When the NeRV model is trained to output the residual block, the NeRV model may utilize the original block as the GT (ground truth), and the loss function may be defined by using the residual, i.e., the difference between the GT and the prediction block.

As a result, the output of the NeRV model, N block, corresponds to the current block's residual block, prediction block, reconstructed block, or loop-filtered block. Regardless of the type of N block, the NeRV model may be trained depending on an appropriate loss function by utilizing the original block as the GT. The video encoding apparatus may further signal the type of N block to the video decoding apparatus. The video decoding apparatus may decode the above-described type of N block, and then apply a video decoding process based on the type of N block to the N block that is the output of the NeRV model. For example, if the N block corresponds to a residual block, the video decoding apparatus generates a prediction block of the current block according to a conventional decoding process, and generates a reconstructed block by summing the N block and the prediction block. If N block corresponds to the prediction block, the video decoding apparatus generates a residual block of the current block according to the conventional decoding process, and generates a reconstructed block by summing the residual block and N block. If the N block corresponds to the reconstructed block, the video decoding apparatus applies loop filtering to the N block. Further, if the N block corresponds to a loop filtered block, the video decoding apparatus stores the frame containing the N block in a decoded picture buffer (DPB). The DPB resides in the memory 570.

The following describes detailed examples of applying the NeRV model to the inter-prediction method.

In a conventional deep learning-based inter prediction, a reference frame at a current time t is generated by using reference frames at past and future time points, and motion prediction and compensation of the current block are performed based on the generated reference frames. Since motion prediction is performed by using the reference frame estimated at the current time, increasing coding efficiency can be expected by reducing the number of bits for representing the motion vector. However, the performance of a deep learning module trained to generate the reference frame at the current time also depends on the features of the samples used for training. This is because the performance of the deep learning module may vary depending on the intensity of the quantized noise, the characteristics of the sensors used to create/generate the content, and the like. To address the above issues, methods for generating reference frames by using the NeRV model and applying them to motion compensation are described herein.

In one example, as illustrated in FIG. 19, the video decoding apparatus generates a reference frame at a current time t by using a NeRV model and stores the generated reference frame in a DPB. The DPB resides in the memory 570. In the same manner as previously decoded video frames, the video decoding apparatus utilizes the stored reference frames for motion prediction and compensation of the current block.

The following describes an approach utilizing multiple NeRV models.

When decoding a single N block or a single N frame, the video decoding apparatus may utilize the above-described single NeRV model. Alternatively, the video decoding apparatus may select one of a plurality of NeRV models and utilize the selected NeRV model. In this case, the video encoding apparatus generates a plurality of NeRV models, selects one of the plurality of NeRV models, and performs encoding of the selected NeRV model. The manner of generating the various NeRV models is based on additional information provided by the video encoding apparatus. For example, different NeRV models may be used depending on the slice type or frame type. Namely, different NeRV models may be used depending on whether the N block in a P frame is to be decoded or the N block in an I frame is to be decoded. Alternatively, different NeRV models may be used depending on the quantization parameters.

In one example, in the encoding pipeline of NeRV models illustrated in FIG. 12, the video encoding apparatus constructs a plurality of NeRV models by setting the model pruner 1220 or the model quantizer 1230 differently. The video encoding apparatus selects the best model in terms of rate distortion from among the constructed NeRV models. By using the above-described encoding pipeline, the video encoding apparatus transfers the selected NeRV model to the video decoding apparatus.

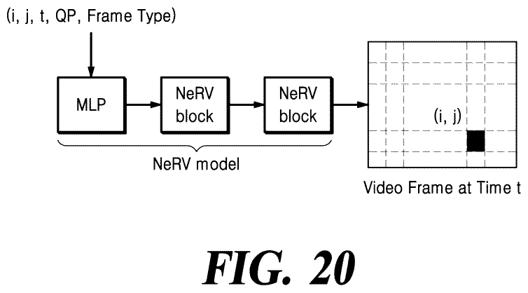

As another example, frame types or quantization parameters are used as input to the NeRV model. In the example of FIG. 20, the video encoding apparatus uses the frame type or quantization parameter, in addition to the time index and the index of the block, as input to the block-based NeRV model.

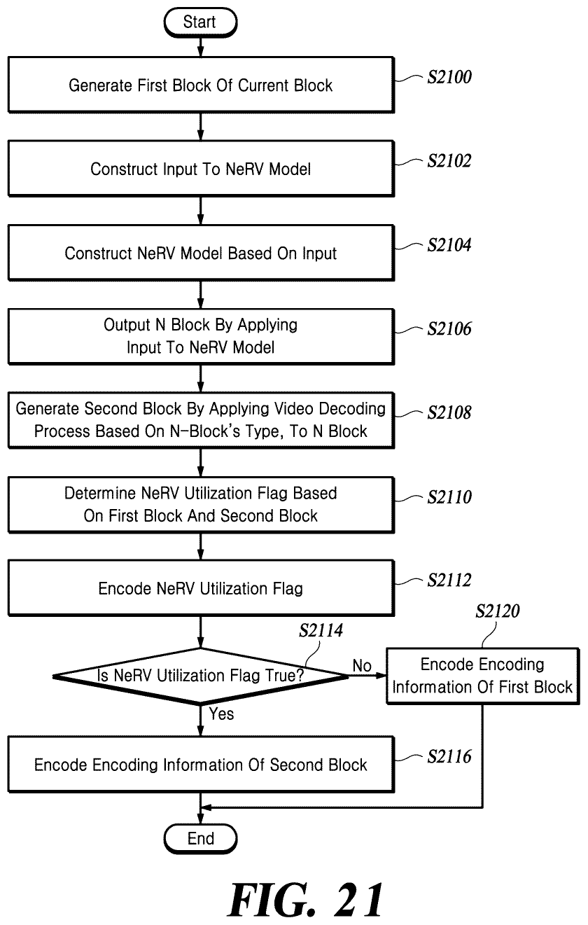

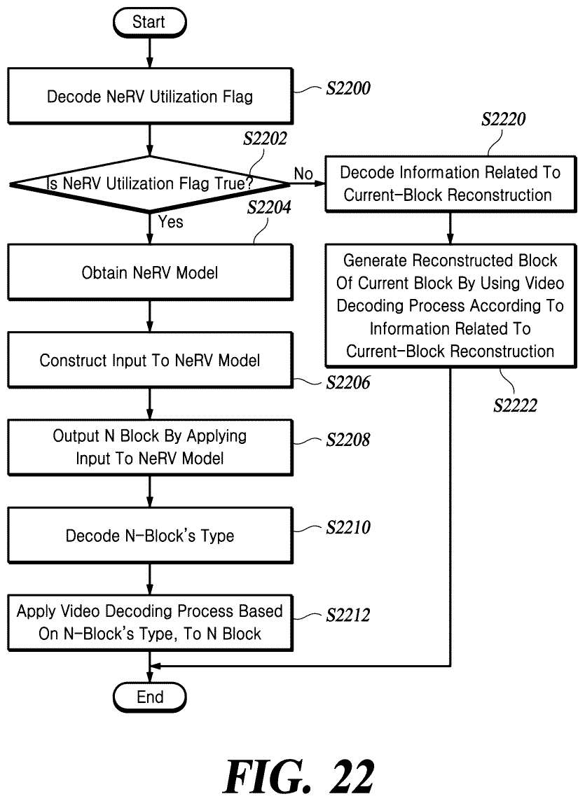

The following describes, with reference to FIGS. 21 and 22, methods of encoding the current block and decoding the current block by using a NeRV model.

FIG. 21 is a flowchart of a method of encoding the current block by the video encoding apparatus, according to at least one embodiment of the present disclosure.

The video encoding apparatus applies a video encoding process to the original block to generate a first block of the current block (S2100). Here, the first block corresponds to a loop filtered block of the current block.

The video encoding apparatus constructs an input to the NeRV model (S2104).

The video encoding apparatus constructs the NeRV model based on the input (S2102).

In one example, the video encoding apparatus may construct the NeRV model by training the NeRV model to reduce a loss function by using the input and the original block, i.e., the GT block. As a loss function, a combination of L1 loss and structural similarity index (SSIM) loss may be used.

As another example, the video encoding apparatus may construct the NeRV model by using parameters of the NeRV model of a previously decoded N block neighboring the current block.

The video encoding apparatus applies the input to the NeRV model to output the N block (S2106). Here, the N block corresponds to the current block's residual block, prediction block, reconstructed block, or loop filtered block.

The video encoding apparatus applies a video decoding process based on the type of the N block, to the N block to generate a second block corresponding to the loop filtered block of the current block (S2108).

The video decoding process applied to the N block is as follows. If the N block corresponds to a residual block, the video encoding apparatus generates a prediction block of the current block, and sums the N block and the prediction block to generate a reconstructed block. If the N block corresponds to the prediction block, the video encoding apparatus generates the residual block of the current block and sums the residual block and N block to generate the reconstructed block. If the N block corresponds to the reconstructed block, the video encoding apparatus applies loop filtering to the N block. Additionally, if the N block corresponds to a loop filtered block, the video encoding apparatus stores the frame containing the N block in the DPB.

The video encoding apparatus determines a NeRV utilization flag based on the first block and the second block (S2110). Here, the NeRV utilization flag indicates whether the NeRV model and N block are utilized. The video encoding apparatus may determine the NeRV utilization flag in terms of rate-distortion optimization. For example, if the first block is optimal, the NeRV utilization flag may be determined to be false. In contrast, if the second block is optimal, the NeRV utilization flag may be determined to be true.

The video encoding apparatus encodes the NeRV utilization flag (S2112).

The video encoding apparatus checks the NeRV utilization flag (S2114).

If the NeRV utilization flag is true (Yes in S2114), the video encoding apparatus encodes the encoding information of the second block.

The type of N block and the parameters of the NeRV model are encoded (S2116).

As described above, the N block corresponds to the current block's residual block, prediction block, reconstructed block, or loop filtered block. The video encoding apparatus determines the type of N block in terms of rate-distortion optimization. The video encoding apparatus encodes the type of N block.

In one example, when constructing a NeRV model through training, the video encoding apparatus encodes the parameters of the NeRV model by using an encoding pipeline as illustrated in FIG. 12.

As another example, when constructing a NeRV model by using parameters of a NeRV model of a previously decoded N block neighboring the current block, the video encoding apparatus encodes an index indicative of the previously decoded N block.

If the NeRV utilization flag is false (No in S2114), the video encoding apparatus encodes the encoding information of the first block (S2120). Here, the encoding information of the first block includes a residual block, a prediction mode, a quantization parameter, a transform kernel, and the like according to a conventional video encoding method.

FIG. 22 is a flowchart of a method of reconstructing the current block by the video decoding apparatus, according to at least one embodiment of the present disclosure.

The video decoding apparatus decodes the NeRV utilization flag from the bitstream (S2200). Here, the NeRV utilization flag indicates whether the NeRV model and N block are to be used.

The video decoding apparatus checks the NeRV utilization flag (S2202).

If the NeRV utilization flag is true (Yes in S2202), the video decoding apparatus performs the following steps.

The video decoding apparatus obtains the NeRV model (S2204).

In one example, the video decoding apparatus decodes the parameters of the NeRV model from the bitstream. By using the decoded parameters, the video decoding apparatus constructs the NeRV model according to a decoding pipeline as illustrated in FIG. 13.

In another example, the video decoding apparatus decodes an index indicative of the previously decoded N block from the bitstream. The video decoding apparatus constructs a NeRV model by using the parameters of the NeRV model of the previously decoded N block indicated by the decoded index.

The video decoding apparatus constructs an input to the NeRV model (S2206).

The video decoding apparatus applies the input to the NeRV model to output the N block (S2208). Here, the N block corresponds to the current block's residual block, prediction block, reconstructed block, or loop filtered block.

The video decoding apparatus decodes the type of N block from the bitstream (S2210).

The video decoding apparatus applies a video decoding process based on the type of N block, to the N block (S2212).

The video decoding process applied to the N block is as follows. If the N block corresponds to a residual block, the video decoding apparatus generates a prediction block of the current block and sums the N block and the prediction block to generate a reconstructed block. If the N block corresponds to the prediction block, the video decoding apparatus generates the residual block of the current block and sums the residual block and the N block to generate the reconstructed block. If the N block corresponds to the reconstructed block, the video decoding apparatus applies loop filtering to the N block. Further, if the N block corresponds to a loop filtered block, the video decoding apparatus stores the frame containing the N block in the DPB.

If the NeRV utilization flag is false (No in S2202), the video decoding apparatus performs the following steps.

The video decoding apparatus decodes the reconstruction information of the current block from the bitstream (S2220). Here, the reconstruction information of the current block includes a residual block, a prediction mode, a quantization parameter, a transform kernel, and the like according to a conventional video decoding method.

The video decoding apparatus generates a reconstructed block of the current block by using a video decoding process according to the reconstruction information of the current block (S2222). The video decoding apparatus may generate the reconstructed block of the current block by utilizing a conventional video decoding process.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

120: predictor
155: entropy decoder
1210: video overfitter
1220: model pruner
1230: model quantizer
1240: weight encoder

### CROSS-REFERENCE TO RELATED APPLICATIONS

This application claims priority to and the benefit of Korean Patent Application No. 10-2023-0035657 filed on Mar. 20, 2023, and Korean Patent Application No. 10-2024-00004603, filed on Jan. 11, 2024, the entire contents of each of which are incorporated herein by reference.

What is claimed is:

1. A method of reconstructing a current block by a video decoding apparatus, the method comprising:
obtaining a model of Neural Representations for Videos (NeRV model);
constructing an input to the NeRV model;
applying the input to the NeRV model to output an N block that corresponds to a residual block of the current block, a prediction block of the current block, a reconstructed block of the current block, or a loop filtered block of the current block;
decoding a type of the N block from a bitstream; and
applying a video decoding process based on a type of the N block, to the N block.

2. The method of claim 1, further comprising:
decoding from the bitstream a NeRV utilization flag that indicates whether the NeRV model and the N block are to be used; and
checking the NeRV utilization flag,
wherein when the NeRV utilization flag is true, performing decoding the NeRV model through applying the video decoding process to the N block.

3. The method of claim 1, wherein obtaining the NeRV model comprises:
decoding parameters of the NeRV model from the bitstream; and
constructing the NeRV model by using the parameters.

4. The method of claim 1, wherein obtaining the NeRV model comprises:
decoding an index indicative of a previously decoded N block from the bitstream; and
constructing the NeRV model by using parameters of the NeRV model of the previously decoded N block.

5. The method of claim 1, wherein constructing the input to the NeRV model comprises:
constructing the input to include an index of the current block in space and a time index of a frame containing the current block.

6. The method of claim 5, wherein constructing the input to the NeRV model comprises:
decoding from the bitstream a local feature that is a feature of the current block or a neighbor block of the current block and is extracted by a deep learning-based extraction model in a video encoding apparatus; and
constructing the input to include the local feature, in addition to the index of the current block and the time index.

7. The method of claim 5, wherein constructing the input to the NeRV model comprises:
embedding the index of the current block and the time index in a high-dimensional space, and constructing the input to include an embedded index of the current block and an embedded time index.

8. The method of claim 1, wherein obtaining the NeRV model comprises:
obtaining different NeRV models based on a type of a frame containing the current block or quantization parameters.

9. The method of claim 8, wherein constructing the input to the NeRV model comprises:
constructing the input to include the type of the frame or the quantization parameters as well as an index of the current block in space and a time index of the frame.

10. The method of claim 1, wherein applying the video decoding process to the N block comprises, when the N block corresponds to the residual block of the current block:
generating the prediction block of the current block, and summing the N block and the prediction block to generate the reconstructed block of the current block.

11. The method of claim 1, wherein applying the video decoding process to the N block comprises, when the N block corresponds to the reconstructed block of the current block:
applying loop filtering to the N block.

12. A method of encoding a current block by a video encoding apparatus, the method comprising:
applying a video encoding process to an original block of the current block to generate a first block that is a loop filtered block of the current block;
constructing an input to a model of Neural Representations for Videos (NeRV model);
constructing the NeRV model based on the input;
applying the input to the NeRV model to output an N block that corresponds to a residual block of the current block, a prediction block of the current block, a reconstructed block of the current block, or a loop filtered block of the current block; and
applying a video decoding process based on a type of the N block, to the N block to generate a second block that corresponds to the loop filtered block of the current block.

13. The method of claim 12, wherein constructing the NeRV model comprises:
constructing the NeRV model by using the input and the original block for training the NeRV model toward reducing a loss function that is a combination of an L1 loss and a structural similarity index loss (SSIM loss).

14. A method of claim 12, wherein constructing the NeRV model comprises:
constructing the NeRV model by using parameters of the NeRV model of a previously decoded N block neighboring the current block.

15. The method of claim 12, further comprising:
determining, based on the first block and the second block, a NeRV utilization flag that indicates whether the NeRV model and the N block are to be used; and
encoding the NeRV utilization flag.

16. The method of claim 15, further comprising:
checking the NeRV utilization flag,
wherein, when the NeRV utilization flag is true and when constructing the NeRV model through training, the method further comprises:
encoding the type of the N block and parameters of the NeRV model.

17. The method of claim 15, further comprising:
checking the NeRV utilization flag,
wherein, when the NeRV utilization flag is true and when constructing the NeRV model by using parameters of the NeRV model of a previously decoded N block neighboring the current block, the method further comprises:
encoding the type of the N block and an index indicative of the previously decoded N block.

18. A computer-readable recording medium storing a bitstream generated by a video encoding method, wherein the video encoding method comprises:
applying a video encoding process to an original block of a current block to generate a first block that is a loop filtered block of the current block;
constructing an input to a model of Neural Representations for Videos (NeRV model);
constructing the NeRV model based on the input;
applying the input to the NeRV model to output an N block that corresponds to a residual block of the current block, a prediction block of the current block, a reconstructed block of the current block, or a loop filtered block of the current block; and
applying a video decoding process based on a type of the N block, to the N block to generate a second block that corresponds to the loop filtered block of the current block.
